(19) United States
(12) Patent Application Publication
(10) Pub. No.: US 2024/0110118 A1
(43) Pub. Date: Apr. 4, 2024

(54) LUBRICATING MEMBER COMPRISING POLYGLUTAMIC ACID

(71) Applicant: The Gillette Company LLC, Boston, MA (US)

(72) Inventors: ALEXANDER SHIH LEE, Quincy, MA (US); Philip Andrew Sawin, Wyoming, OH (US); Paul Martin Lipic, West Chester, OH (US); Michael John Moloney, Brimfield, MA (US)

(21) Appl. No.: 18/239,144

(22) Filed: Aug. 29, 2023

Related U.S. Application Data
(63) Continuation-in-part of application No. 17/944,839, filed on Sep. 14, 2022, now abandoned.

(51) Int. Cl. C10M 107/44; B26B 21/44; C10M 107/34

(52) U.S. Cl. CPC C10M 107/44; B26B 21/443; C10M 107/34; C10M 2209/1045; C10M 2217/0443; C10N 2050/08

(57) ABSTRACT

A lubricating member for a hair removal device, in which the lubricating member includes a lubricating material, in which the lubricating material includes a polyglutamic acid (PGA) material. Also disclosed is a lubricating composition including: a matrix material and a lubricating material, in which the lubricating material includes a PGA material and the PGA includes at least 5% of the lubricating composition by weight. Also disclosed is a method of forming a corresponding lubricating member.

### FIELD OF THE INVENTION

The present disclosure is directed to lubricating members and lubricating compositions, and specifically a lubricating member and a lubricating composition comprising polyglutamic acid material and a hair removal device comprising the lubricating member.

### BACKGROUND OF THE INVENTION

Hair removal devices such as razors and hair removal heads such as razor cartridges often incorporate shaving aids to provide lubrication benefits during use. Shaving aids can take a variety of forms. One common form is a lubricating member or lubristrip, which is typically integrated into the hair removal head such as the cartridge of a razor to provide lubrication during shaving. Another common form is a “wing” or “soap wing,” which is disposed outward of the cartridge and generally attached to it. Other common forms include lubricating compositions that may be used separately from the hair removal device or dispensed from a container within the hair removal device.

Shaving aids comprise a lubricant and may optionally comprise a matrix material in which the lubricant is dispersed. The lubricant is commonly composed, at least partly, of polyethylene oxide (PEO). PEO is a high molecular weight, water-soluble polymer, and when activated by water during shaving, the PEO deposits onto the skin, adding a layer of lubrication. PEO in water is a viscoelastic fluid, and the rheological properties are directly correlated to the coefficient of friction (CoF) of the fluid.

As the consumer market shifts towards more sustainable and natural landscapes, there is increasing interest to replace synthetic materials like PEO in grooming product formulations. Furthermore, PEO is oftentimes preserved with butylated hydroxytoluene, which may be perceived negatively. While PEO replacements have been considered, these alternatives generally do not provide the viscoelastic properties that are helpful in grooming formulations to protect the skin by, for example, providing a cushioning effect between the razor blade and the skin. For example, sodium carboxymethylcellulose, which is a thickener used in skin care compositions, can provide lubricity during shaving but has a cyclic molecular structure that is believed to inhibit the backbone flexibility helpful in achieving a lubricant with all the desired properties. Therefore, there remains a need to find a replacement for PEO that maintains the desirable properties of PEO, including skin lubrication.

### SUMMARY OF THE INVENTION

In accordance with one aspect of the present disclosure, a lubricating member for a hair removal device is provided, in which the lubricating member comprises a lubricating material, the lubricating material comprising a polyglutamic acid (PGA) material.

In accordance with another aspect of the present disclosure, a lubricating composition is provided, in which the lubricating composition comprises a matrix material and a lubricating material. The lubricating material comprises a polyglutamic acid (PGA) material, in which the PGA material comprises at least 5% of the lubricating composition by weight.

In accordance with another aspect of the present disclosure, a method of forming a lubricating member for use on a hair removal device is provided, the method comprising: providing a matrix material; providing a lubricating material, in which the lubricating material is a polyglutamic acid material; blending the matrix material with the lubricating material to form a mixture; and forming a lubricating member from the mixture.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements.

FIGS. 1A-1H are perspective views of a razor cartridge comprising various lubricating members in accordance with the present disclosure.

FIGS. 2A and 2B are graphs showing the viscous and elastic moduli of various lubricating member formulations.

FIG. 3 is a bar graph showing an average performance score of various lubricating member formulations during a use test.

FIG. 4 is a flowchart illustrating an exemplary process for forming a lubricating member for use on a hair removal device, in accordance with the present disclosure.

FIG. 5 is a graph depicting the viscosity gain for a series of mixtures of PGA and PEO.

### DETAILED DESCRIPTION OF THE INVENTION

The present disclosure relates to a lubricating member and a hair removal device comprising the lubricating member, in which the lubricating member includes a lubricating material that includes a polyglutamic acid (PGA) material and, optionally, a matrix material. The present disclosure also relates to methods of forming a lubricating member for use on a hair removal device. The present disclosure further relates to a lubricating composition comprising a matrix material and a lubricating material comprising PGA material. Without wishing to be bound by theory, it is believed that the lubricating materials of the present disclosure replace and/or supplement polyethylene oxide (PEO) with PGA material while maintaining desirable properties, such as skin lubrication.

PGA material is currently used in a wide variety of industries such as water treatment, drug delivery, and skin care formulations. With respect to skin care formulations, PGA material is typically used to retain moisture (i.e., as a humectant), to reduce wrinkles and other effects of aging, and to promote wound healing. PGA material is generally not used for its lubricating properties. It was surprisingly found that use of PGA material in lubricating members and lubricating compositions in sufficiently high levels, e.g., at least 5% by weight of the lubricating member or composition, is capable of delivering adequate lubrication during shaving. PGA material is a natural product that can be produced using fermentation and can be used to replace, or reduce the amount of, the synthetic materials currently found in lubricating members and compositions. In particular, it was surprisingly found that PGA material could be used as an effective replacement for PEO, which has a lower melting temperature than PGA material, while still maintaining the desirable properties of PEO.

### Hair Removal Device

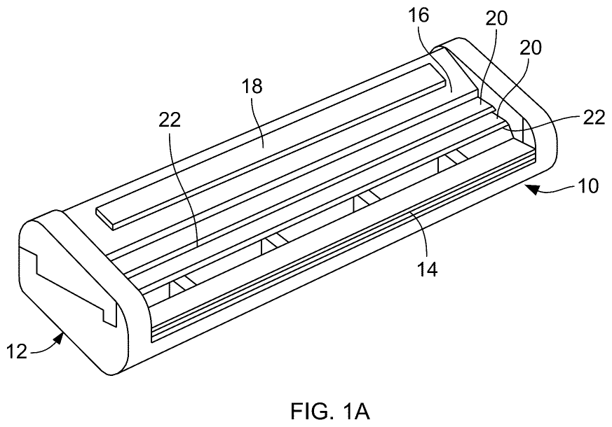

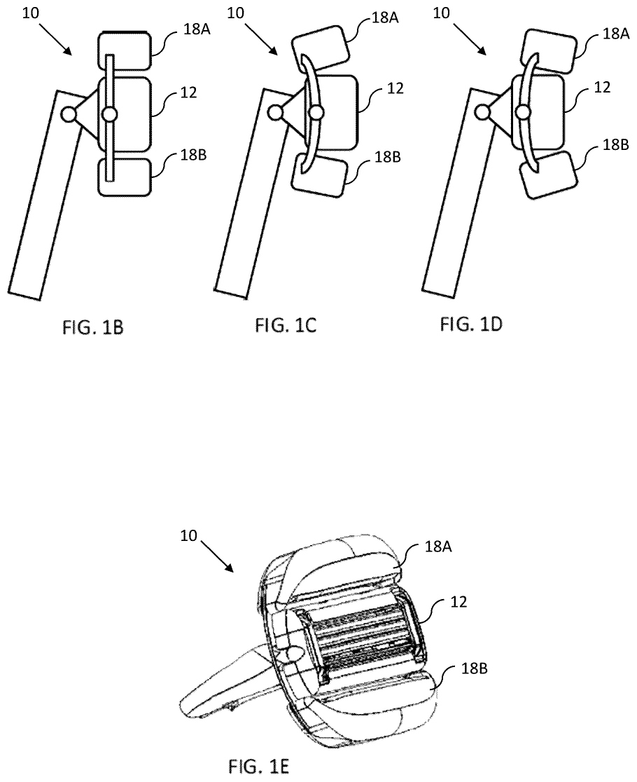

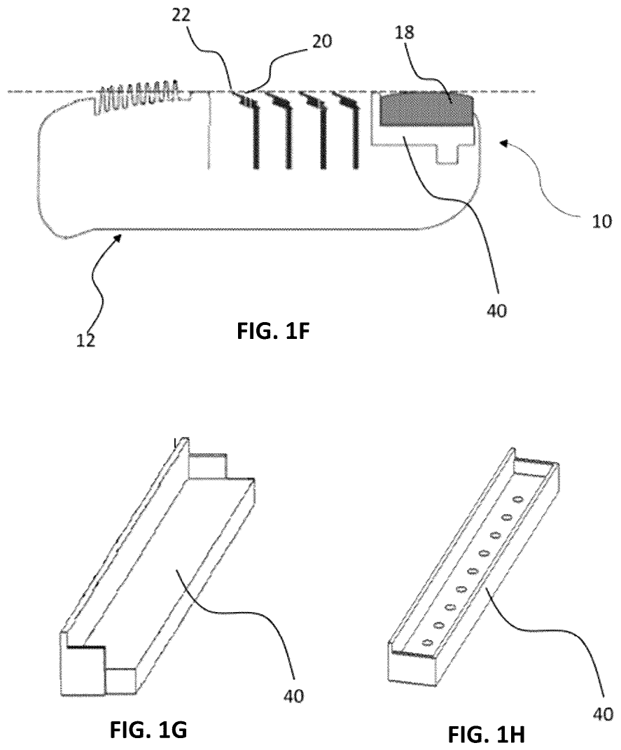

According to some examples of the disclosure, the lubricating member finds particular application for hair removal devices. Hair removal devices generally comprise a hair removal head and a handle or grip portion upon which the hair removal head is mounted, either permanently or detachably/attachably. The hair removal device can be manual, or power driven and can be used for wet and/or dry application. In some examples, the hair removal head may include a wide scraping surface, such as where the hair removal device is used with a depilatory, or a blade where the device is a shaving razor. In other examples, the hair removal head may be a razor cartridge 10, as shown in FIG. 1A.

The hair removal head may be pivotally connected to a connecting structure that in turn, or independently (e.g., permanently fixed), is connected to the handle. In some examples, the connecting structure includes at least one arm to releasably engage the hair removal head. The hair removal head may be integral with the handle so that the hair removal device is discarded as a whole unit or may comprise a detachable hair removal head that forms part of a shaving system, in which the detachable hair removal head is uncoupled from the handle and disposed of and a new detachable hair removal head is coupled to the same handle.

The hair removal head typically comprises one or more blades usually positioned between a first and second end, the one or more blades comprising a tip (also commonly called a blade “edge”) extending forwardly. With reference to FIG. 1A, where the hair removal head is a razor cartridge 10, the razor cartridge 10 may comprise a housing 12. One or more razor blades 20 may be incorporated into the housing 12, in which each blade 20 includes a blade edge comprising a blade tip 22.

A variety of razor cartridges can be used in accordance with the present disclosure. For example, U.S. Pat. No. 7,168,173 generally describes a FUSION® razor that is commercially available from The Gillette Company, and which includes a razor cartridge with multiple blades. Non-limiting examples of suitable razor cartridges, with and without fins, guards, and/or shave aids, include those marketed by The Gillette Company under the FUSION®, VENUS® product lines (Gillette) as well as those disclosed in U.S. Pat. Nos. 7,197,825, 6,449,849, 6,442,839, 6,301,785, 6,298,558, 6,161,288, and U.S. Patent Application Publication No. 2008/0060201. Those of skill in the art will understand that the lubricating member can be used with any currently marketed razor or shaving system, including those having two, three, four, or more blades. In such a case, the hair removal device is a razor, and the hair removal head is a razor cartridge. Another example of a hair removal device is a scraping tool for use with a hair removal composition, i.e., a depilatory. Additionally, the hair removal device may be a liquid dispensing razor (LDR), which is described in U.S. Pat. No. 9,216,514.

With reference to FIG. 1A, in some examples, at least one lubricating member 18 is located on a portion of the housing 12, i.e., a lubricating surface, that contacts the skin during the hair removal process. The blade tips of the one or more razor blades 20 are exposed on the lubricating surface of the housing 12. The one or more lubricating members 18 may be located forward and/or aft of the blades 20. A feature “forward” of the one or more blades 20, for example, is positioned so that the surface to be treated by the hair removal device (e.g., the user's skin) encounters the feature before it encounters the blades 20. A feature “aft” of the one or more blades 20 is positioned so that the surface to be treated by the hair removal device encounters the feature after it encounters the blades 20.

In the example shown in FIG. 1A, a lubricating member 18 is positioned on a cap 16 of the razor cartridge 10. In other examples, a plurality of lubricating members may be provided on the hair removal head, in which the plurality of lubricating members may be the same or different in terms of physical shape/structure and/or chemical composition. These lubricating members may be placed collectively (for example adjacent to one another) forward or aft of the blades, including side by side, or separately with one ahead of the blades and the other behind. In some examples, such as the examples shown in FIGS. 1B-1E, lubricating members may be positioned outward of the razor cartridge (or hair removal head) as “wings”. As shown in FIGS. 1B-1D, one or both of the lubricating members 18A, 18B can bend forward and back if the rest of the razor cartridge 10 is in a locked position such as locked into an at rest position.

The lubricating member may be separate from or attached to the hair removal device or head. The lubricating member may be attached to the hair removal device or head by any suitable attachment means such as adhesive or interference fit or may be contained at least partially within a container, such as a tray. Exemplary embodiments of lubricating members contained in containers include U.S. Patent Application Publication Nos. 2011/0041865 and 2012/0023763. As shown in FIGS. 1F-1H, the lubricating member 18 may be formed in a container 40 by any means. The lubricating member 18 may be compressed directly in the container 40, such as a tray as shown in FIG. 1G, or into a box as shown in FIG. 1H.

In some examples, as shown in FIGS. 1A-1C, the cartridge 10 comprises a guard 14 comprising at least one elongated flexible protrusion (not separately labeled) to engage a user's skin. The at least one flexible protrusion may comprise flexible fins generally parallel to the one or more blades 20. The at least one flexible protrusion may additionally or alternatively comprise flexible fins comprising at least one portion that is not generally parallel to the one or more blades. Non-limiting examples of suitable guards include those used in current razor blades and include those disclosed in U.S. Pat. Nos. 7,607,230 and 7,024,776; (disclosing elastomeric/flexible fin bars); and U.S. Patent Application Publication Nos. 2008/0034590 (disclosing curved guard fins) and 2009/0049695A1 (disclosing an elastomeric guard having guard forming at least one passage extending between an upper surface and a lower surface). In some examples, the lubricating member is positioned on the cartridge aft of the guard and forward of the blades. In another example, the lubricating member is positioned on the cartridge forward of the guard. This example can be particularly useful to deliver the lubricating member prior to contact with the guard.

### Lubricating Material

The lubricating member and/or lubricating composition may comprise a lubricating material comprising a polyglutamic acid (PGA) material, which provides lubrication during the shave. In some examples, the lubricating material may further include an additional PGA material, polyethylene oxide (PEO), carbohydrates, polyvinyl pyrrolidone, polyacrylamide, polyhydroxymethacrylate, polyvinyl imidazoline, polyethylene glycol (PEG), polyvinyl alcohol, polyhydroxyethylmethacrylate, copolymers of PEO and polypropylene oxide (PPO), guars, celluloses, modified celluloses, and mixtures thereof. Preferably, the lubricating material is the PGA material. In some examples, the lubricating material may comprise the PGA material and one or more second lubricating materials comprising one or more of PEO and a carbohydrate.

According to the present disclosure, in some examples, the lubricating member and/or lubricating composition may comprise a lubricating material comprising at least 5%, and preferably at least 10%, by weight of the lubricating member or composition. In some examples, the lubricating material may comprise from 5% to 90% by weight of the lubricating member or composition. In some particular examples, the lubricating material may comprise 5% to 80%, and preferably 30% to 70%, by weight of the lubricating member or composition. In other particular examples, the lubricating material may comprise 30% to 70% by weight of the lubricating member or composition, particularly when the lubricating material comprises PGA material alone. In examples in which the lubricating material is contained in a container, such as a tray, the lubricating material may comprise 100% PGA material by weight of the lubricating member or composition. Without wishing to be bound by theory, it is believed that an amount of PGA material greater than or equal to 5%, and preferably greater than or equal to 10%, by weight of the lubricating member or composition is needed to achieve viscoelastic and other properties comparable to a conventional lubricating member or composition, such as a conventional lubricating member or composition comprising PEO as the primary lubricating material.

The lubricating material may include a water-soluble polymer, especially PGA material, that may have a weight-average molecular weight of at least 100,000 Daltons, preferably 1 million Daltons, and more preferably 2 million Daltons or greater. Without intending to be bound by theory, it is believed that a lubricating material with a higher molecular weight leads to better performance by the lubricating member or composition. As discussed below, lubricating members comprising PGA material with a molecular weight of 2 million Daltons performed similarly to lubricating members comprising PEO.

In accordance with the present disclosure, the water-soluble polymer exhibits the necessary flexibility that is believed to limit viscoelastic properties and lubricity. Preferably, the water-soluble polymer comprises a PGA material, which may include PGA, PGA salts, and PGA derivatives. Preferred PGA materials may have the general formula of:

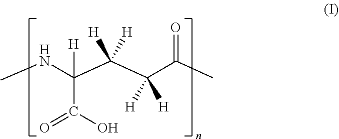

where n may have a value of greater than 700.

PGA material is a naturally derived polymer that may be produced via renewable methods such as fermentation. Specifically, the PGA material may be derived from bacterial fermentation of soybeans using known methods. PGA materials useful in the present invention may include PGA derivatives (i.e., materials in which a C—H bond is replaced with a C—R bond, where R represents a non-hydrogen moiety) crosslinked PGA materials and various PGA salts, such as, but not limited to γ-PGA (H form), Na-PGA, K-PGA, Ca-PGA, Mg-PGA, NH₄-PGA, and mixtures thereof.

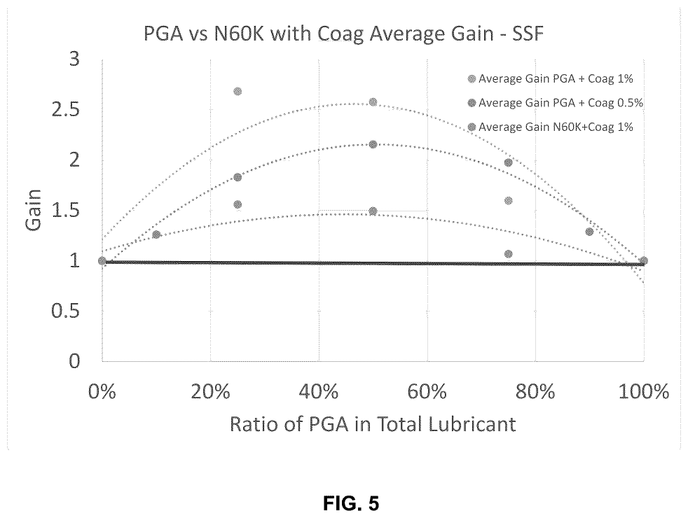

It has further been found that PGA together with PEO offers surprising synergies with respect to lubricity measures. Increased lubricity is associated with increased viscosity of the lubricating material when dissolved in water. FIG. 5 depicts the viscosity gain for a series of mixtures of PGA and PEO. The figure depicts the viscosity gain for mixtures of PGA with a high-MW PEO as compared with the viscosity gain for a Low-MW PEO with the same high-MW PEO. The PGA/PEO mixture was assessed as a 0.5% (w/w) solution in water and as a 1.0% (w/w) solution in water. The PGA/PEO ratio was varied from 100:0 to 0:100 with interim ratios forming the curve and depicts an increased synergy in the PGA/PEO mixtures than in the PEO/PEO mixture.

### Matrix Material

The lubricating member and/or lubricating composition may comprise a matrix material that provides structural integrity to the lubricating member or composition and may enhance the life of the lubricating material by reducing its tendency to be mechanically eroded. Advantageously, the matrix material may be solid at standard temperature and pressure. The lubricating member or composition may comprise from 1% to 77%, preferably from 10% to 40%, and more preferably from 20% to 40% by weight of the matrix material.

The matrix material may comprise a polymer or a molecular structurant. In some examples, the polymer may comprise a matrix polymer such as ethylene vinyl acetate (EVA). Examples of lubricating members comprising EVA may be found in, for example, U.S. Pat. Nos. 5,349,750 and 10,682,778. In other examples, the polymer may comprise a polymeric matrix material such as high impact polystyrene (HIPS). Examples of lubricating members comprising HIPS may be found in, for example, U.S. Pat. No. 8,236,214 and U.S. Patent Application Publication No. 2013/0042482. Further examples of a matrix polymer may include ethyl cellulose; polycaprolactone (PCL); polyethylene, polypropylene; polystyrene; butadiene-styrene copolymer (e.g., medium impact polystyrene and HIPS); polyacetal; acrylonitrile butadiene-styrene (ABS) copolymer; polyurethane; and blends such as polypropylene/polystyrene blend, and mixtures thereof. Examples of lubricating members comprising PCL may be found in, for example, U.S. Pat. No. 6,301,785. In one example, the polymer comprises one of EVA or HIPS.

Lubricating members comprising HIPS are typically formed by extruding a mixture that is heated to approximately 200° C. and exposed to shear during extrusion. These high processing temperatures and high shear conditions may limit the stability of the lubricating material and/or the viability of compatible stabilizing agents. As such, the use of a lower temperature processable polymer matrix material such as EVA, which requires a lower processing temperature of approximately 130° C., or a melt-formed composition may be preferable.

Lubricating compositions and melt-formed lubricating members may include a non-polymeric structurant as part of the matrix material, in which the non-polymeric structurant has a melt temperature of less than 100° C. In some examples, the non-polymeric structurant may comprise one or more lipophilic structurants. Suitable lipophilic structurants for use herein include C₁₂ or greater, preferably C₁₂ to C₂₂, more preferably C₂₀ to C₂₂, chain length fatty acyls such as fatty acids, salts of fatty acids (i.e. “soaps”), fatty alcohols and esters, triglycerides, waxes, and mixtures thereof. Particularly preferred are C₁₂-C₂₂ alcohols, acids, and soaps, in particular cetyl, stearyl, and behenyl alcohols and mixtures thereof. In one example, the structurant comprises behenyl alcohol.

Suitable lipophilic structurants also include natural, synthetic, and silicone waxes. As used herein, the term “wax” includes, but is not limited to, any material that is solid at 45° C., preferably at 25° C.; and are very slightly soluble in water, preferably practically insoluble in water according to the United States' Pharmacopeia (USP) definition in 31/NF 26 Vol. 2 General Notices, Page Xvii. According to that definition, this means that 1000 to 10000 parts of water are needed to dissolve 1 part solute and that more than 10,000 parts of water are needed to dissolve 1 part solute respectively.

The wax may comprise natural wax, synthetic wax or mixtures thereof. Natural waxes may be plant, animal or mineral derived. Non-limiting examples of suitable natural waxes include Beeswax, Copernicia cerifera (Carnauba) Wax, Euphorbia cerifera (Candelilla) Wax, Jojoba Wax, Oryza sativa (Rice) Bran Wax, Lemon peel wax, Soybean wax, Sunflower wax and mixtures thereof.

Non-limiting examples of suitable synthetic waxes include Hydrogenated Jojoba Wax, synthetic and siliconyl jojoba wax, Hydrogenated Microcrystalline Wax, Microcrystalline Wax, synthetic, siliconyl and Hydrogenated Rice Bran Wax, Ceresin, Ozokerite, Paraffin, behenyl beeswax, synthetic, siliconyl and hydrogenated Beeswax, synthetic, hydrogenated and siliconyl Candelilla Wax, synthetic, hydrogenated and siliconyl Carnauba, wax, synthetic, hydrogenated and siliconyl lemon peel wax, synthetic, siliconyl and hydrogenated soybean wax, synthetic, siliconyl and hydrogenated sunflower wax and mixtures thereof. Preferred natural and synthetic waxes are Beeswax, Microcrystalline wax, Candellila wax, Ozokerite, and mixtures thereof.

Non-limiting examples of suitable silicone waxes include Stearoxy trimethylsilane such as DC580 wax, C₃₀-C₄₅ alkyl methicone available as DC AMS-C30 Cosmetic Wax, stearoxymethyl silane available as DC Silkywax 10, C₂₄-C₅₄ alkyl methicone such as DC ST-Wax 30, C₃₀-C₄₅ Alkyldimethylsilyl, Polypropyl-silsesquioxane, available as DC SW-8005 resin wax, and mixtures thereof.

The lipophilic structurant and/or lubricating member or composition may comprise from 10% to 60% lathering surfactant. Examples of lubricating compositions comprising lathering surfactants may be found in, for example, U.S. Pat. No. 9,119,796. A lathering surfactant is defined as a surfactant which when combined with water and mechanically agitated generate a foam or later. Lathering surfactants include anionic and amphoteric lathering surfactants and mixtures thereof. Anionic lathering surfactants include sarcosinates, sulfates, sulfonate, isethionate, taurates, phosphates, lactylates, glutamates, alkali metal salts of fatty acids (i.e., soaps) having from 8 to 24 carbons, and mixtures thereof.

### Liquid Phase

The lubricating member may further comprise from 1% to 70%, preferably from 5% to 60%, and more preferably from 10% to 40% by weight of the lubricating member of a liquid phase. In one aspect, the liquid phase comprises a hydrophobic material or mixtures thereof. The liquid phase may provide a number of in use benefits such as lubrication, skin feel, skin health, and cooling sensation. The liquid phase is generally contained within the solid lubricating member by the matrix material.

In one example, the liquid phase may have a melting point of 45° C. or less, preferably 40° C. or less, even more preferably 30° C. or less, most preferably 25° C. or less. The melting point is determined according to ASTM D5440-93. Preferably the liquid phase and the hydrophobic material is liquid at 25° C. The use of a liquid phase enables the materials such as the lipophilic structurant to be readily added and mixed upon melting thereof. In another example, the liquid phase hydrophobic material or mixtures thereof may be very slightly soluble and have a melting point of 45° C. or less, as defined herein above, and be miscible with one another. In another example, the melting point of the mixture of liquid phase and the lipophilic structurant is preferably from 45° C. to 5° C. less than the melting point of the lubricating material and/or the water-soluble polymer.

Suitable liquid phase components for use herein include for example natural oils, synthetic oils, silicone oils, petrolatum, triglycerides, butters, or mixtures thereof. As used herein, the term “oil” includes, but is not limited to any non-aqueous substance that is very slightly soluble, preferably practically insoluble in water according to the 'USP definition. Petrolatum may be considered as a lipophilic structurant or a liquid phase due to it being a complex mixture of component materials.

The oil may be selected from natural oil, synthetic oil, silicone oil and mixtures thereof. Non-limiting examples of suitable natural oils include Acetylated Castor Oil, Acetylated Hydrogenated Castor Oil, Actinidia chinensis (Kiwi), Seed Oil, Adansonia digitata Oil, Aleurites moluccana Seed Oil, Anacardium occidentale (Cashew) Seed Oil, Arachis hypogaea (Peanut) Oil, Arctium lappa Seed Oil, Argania spinosa Kernel Oil, Argemone mexicana Oil, Avena sativa (Oat) Kernel Oil, Bertholletia excelsa Seed Oil, Borago officinalis Seed Oil, Brassica campestris (Rapeseed) Seed Oil, Calophyllum tacamahaca Seed Oil, Camellia japonica Seed Oil, Camellia kissi Seed Oil, Camellia oleifera Seed Oil, Canola Oil, Caprylic/Capric/Lauric Triglyceride, Caprylic/Capric/Linoleic Triglyceride, Caprylic/Capric/Mystic/Stearic Triglyceride, Caprylic/Capric/Stearic Triglyceride, Caprylic/Capric Triglyceride, Carthamus tinctorius (Hybrid Safflower) Seed Oil, Carthamus tinctorius (Safflower) Seed Oil, Carum carvi (Caraway) Seed Oil, Carya illinoensis (Pecan) Seed Oil, Castor Oil Benzoate, Chenopodium quinoa Seed Oil, Cibotium barometz Oil, Citrullus vulgaris (Watermelon) Seed Oil, Cocos nucifera (Coconut) Oil, Cod Liver Oil, Coffea arabica (Coffee) Seed Oil, Coix lacryma-jobi (Job's Tears) Seed Oil, Corylus americana (Hazel) Seed Oil, Corylus avellana (Hazel) Seed Oil, Cucumis sativus (Cucumber) Oil, Cucurbita pepo (Pumpkin) Seed Oil, Daucus carota sativa (Carrot) Seed Oil, Elaeis guineensis (Palm) Kernel Oil, Elaeis guineensis (Palm) Oil, Gossypium (Cotton) Seed Oil, Helianthus annuus (Hybrid Sunflower) Oil, Helianthus annuus (Sunflower) Seed Oil, Hippophae rhamnoides Oil, Human Placental Lipids, Hydrogenated Canola Oil, Hydrogenated Castor Oil, Hydrogenated Castor Oil Laurate, Hydrogenated Castor Oil Triisostearate, Hydrogenated Coconut Oil, Hydrogenated Cottonseed Oil, Hydrogenated C12-18 Triglycerides, Hydrogenated Fish Oil, Hydrogenated Lard, Hydrogenated Menhaden Oil, Hydrogenated Mink Oil, Hydrogenated Olive Oil, Hydrogenated Orange Roughy Oil, Hydrogenated Palm Kernel Oil, Hydrogenated Palm Oil, Hydrogenated Peanut Oil, Hydrogenated Rapeseed Oil, Hydrogenated Shark Liver Oil, Hydrogenated Soybean Oil, Hydrogenated Sunflower Seed Oil, Hydrogenated Tallow, Hydrogenated Vegetable Oil, Isatis tinctoria Seed Oil, Juglans regia (Walnut) Seed Oil, Lauric/Palmitic/Oleic Triglyceride, Umnanthes alba (Meadowfoam) Seed Oil, Unum usitatissimum (Linseed) Seed Oil, Lupinus albus Seed Oil, Macadamia integrifolia Seed Oil, Macadamia ternifolia Seed Oil, Maleated Soybean Oil, Mangifera indica (Mango) Seed Oil, Marmot Oil, Melaleuca alternifolia (Tea Tree) Leaf Oil, Melia azadirachta Seed Oil, Melissa officinalis (Balm Mint) Seed Oil, Menhaden Oil, Mink Oil, Moringa pterygosperma Seed Oil, Mortierella Oil, Neatsfoot Oil, Nelumbium speciosum Flower Oil, Nigella sativa Seed Oil, Oenothera biennis (Evening Primrose) Oil, Olea europaea (Olive) Fruit Oil, Olea europaea (Olive) Husk Oil, Orange Roughy Oil, Orbignya cohune Seed Oil, Orbignya oleifera Seed Oil, Oryza sativa (Rice) Bran Oil, Oryza sativa (Rice) Germ Oil, Ostrich Oil, Oxidized Corn Oil, Oxidized Hazel Seed Oil, Papaver orientate (Poppy) Seed Oil, Passiflora edulis Seed Oil, Persea gratissima (Avocado) Oil, Pistacia vera Seed Oil, Placental Lipids, Prunus amygdalus amara (Bitter Almond) Kernel Oil, Prunus amygdalus dukis (Sweet Almond) Oil, Prunus armeniaca (Apricot) Kernel Oil, Prunus avium (Sweet Cherry) Seed Oil, Prunus cerasus (Bitter Cherry) Seed Oil, Prunus persica (Peach) Kernel Oil, Pyrus malus (Apple) Oil, Ribes nigrum (Black Currant) Seed Oil, Ricinus communis (Castor) Seed Oil, Rosa canina Fruit Oil, Rosa moschata Seed Oil, Salmon Oil, Salvia hispanica Seed Oil, Santalum album (Sandalwood) Seed Oil, Sesamum indicum (Sesame) Seed Oil, Shark Liver Oil, Solanum lycopersicum (Tomato) Seed Oil, Soybean Lipid, Sphingolipids, Taraktogenos kurzii Seed Oil, Telphairia pedata Oil, Vegetable Oil, Vitis vinifera (Grape) Seed Oil, Zea mays (Corn) Germ Oil, Zea mays (Corn) Oil mineral oil and mixtures thereof.

Suitable synthetic oils include hydrocarbons, esters, alkanes, alkenes, and mixtures thereof. Non-limiting examples include isopropyl palmitate, isopropyl stearate, isohexadecane, isododecane, polyglyceryl triisostearate and mixtures thereof.

Non-limiting examples of suitable silicone oils include dimethicones (including partial esters of dimethicones and fatty acids derived from natural/synthetic oils), cyclomethicones, phenylated silicones, phenyl trimethicones, trimethyl pentaphenyl trisiloxane, silicone polyether block copolymers and mixtures thereof.

Suitable silicone polyether copolymers may comprise from 1% to 50%, by weight of PEO, from 20% to 90% by weight of PPO, and from 1% to 20% by weight of silicone. Preferably, the silicone polyether copolymer comprises at least 40%, more preferably at least 50%, most preferably at least 60%, by weight of PPO. In addition, the silicone polyether copolymer preferably comprises at least 10%, more preferably from at least 15%, most preferably from 15% to 30% by weight of PEO. Furthermore, the silicone polyether block copolymer comprises from 1% to 20%, preferably 10% to 20%, more preferably 15% by weight of silicone.

While silicone polyether block copolymers are known in the art to provide a number of benefits such as foaming, defoaming, wetting, deaeration and lubricity, it has been found that the selection of silicone block copolymers having from 20% to 90% by weight of PPO and from 1% to 50% of PEO further provide improved lubrication whilst ensuring the required level of water dispersion and or solubility, versus silicone polyether block copolymers having less or no PPO and more PEO. Furthermore, the inclusion of 1% to 20% of silicone by weight of the silicone polyether block copolymer provides desirable levels of lubrication despite being present at low levels in the polymer.

The copolymers are block copolymers and may have a linear block or pendant graft structure. The silicone polyether block copolymer preferably has a ratio of PEO units to PPO units of from 3.0 to 0.1, preferably from 2.0 to 0.1, more preferably from 0.6 to 0.25. The silicone polyether block copolymer preferably has a ratio of PEO units to PPO units to silicone units of from 20:65:15.

The silicone polyether copolymer may have a molecular weight of from 10000 to 19000 Daltons, more preferably from 10000 to 15000 Daltons. Suitable silicone polyether copolymers are available from Momentive under the SILWETS® trademark products including L7210, L7602, L7220, L7230, L7500, preferably L7210 and L7602.

Non-limiting examples of commercially available silicone oils include Dow Corning 200 fluid, Dow Corning 244, Dow Corning 245, Dow Corning 344, and Dow Corning 345, (commercially available from Dow Corning Corp.); SF-1204 and SF-1202 Silicone Fluids (commercially available from G.E. Silicones), GE 7207 and 7158 (commercially available from General Electric Co.); and SWS-03314 (commercially available from SWS Silicones Corp.), the Viscasil series (sold by General Electric Company), SF 1075 methyl-phenyl fluid (sold by General Electric Company) and 556 Cosmetic Grade Fluid (sold by Dow Corning Corp.), Silshine 151 (sold by Momentive), PH1555 and PH1560 (sold by Dow Corning) and Silwets such as Silwets 7210, 7230 and 7220 (available from by Momentive).

Suitable triglycerides, may have the following formula:

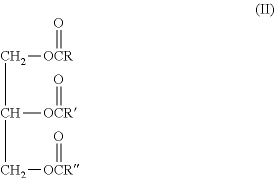

in which R, R′, and R″ may be the same as, or different from, one or both of the others, and in which each of R, R′, and R″ is a fatty acid and the triglyceride is solid at 25° C.

Suitable oils from which triglycerides may be formed include, but are not limited to, the oils listed herein. Suitable fatty acids for formation of triglycerides include, but are not limited to, Myristoleic acid, Palmitoleic acid, Sapienic acid, Oleic acid, Linoleic acid, α-Linolenic acid, Arachidonic acid, Eicosapentaenoic acid, Docosahexaenoic acid, Lauric acid (C₁₂), Myristic acid (C₁₄), Palmitic acid (C₁₆), Stearic acid (C₁₈), Arachidic acid (C₂₀) and mixtures thereof.

Specific sources of triglycerides suitable for inclusion herein include Shea Butter, Theobroma cacao (Cocoa) Seed Butter, Cocoa Butter, Mangifera indica (Mango) Seed Butter, Kokum Butter, and mixtures thereof. Particularly preferred are shea butter, cocoa butter and mixtures thereof.

Preferred liquid phase components may be selected from capric and or caprylic triglycerides, olive oil, shea butter, cocoa butter, petrolatum, isopropyl isostearate, dimethicones, phenylated silicones, silicone polyether block copolymers and mixtures thereof. The silicone polyether block polymers are particularly advantageous as they may facilitate the dispersion of the water-soluble polymer in the lipophilic structurant as discussed hereinafter and may also improve lubrication.

### Optional Benefit Agents

According to the present disclosure, the lubricating member may optionally further comprise a hydrophobic compound or mixtures thereof. In one example, the lubricating member may comprise from 1% to 40%, preferably from 5% to 40%, more preferably from 10% to 40%, even preferably from 12% to 30% by weight of a hydrophobic compound and or mixtures thereof. Suitable hydrophobic compounds include natural oils, waxes, and/or fats; synthetic waxes or oils; triglycerides; skin active agents; sensates; fragrance oils; silicones; and mixtures thereof. The hydrophobic compound can provide a number of in use benefits such as lubrication, skin feel, skin health, and cooling sensation.

The hydrophobic compound may comprise skin active agents such as, but not limited to, oil soluble vitamins, such as vitamin E derivatives, including vitamin E acetate and tocopherol nicotinate; oil-soluble vitamin A derivatives, such as retinyl palmitate; lanolin; ceramides; sterols and sterol esters; salicylic acid; camphor; eucalyptol; essential oils; peppermint oil; ISO E SUPER® [(1-(1,2,3,4,5,6,7,8-octahydro-2,3,8,8-tetramethyl-2-naphthalenyl)ethanone] (International Flavors & Fragrances Inc.); and mixtures thereof.

In some examples, the hydrophobic compound may comprise one or more sensates. Among synthetic coolants, many are derivatives of, or are structurally related to, menthol, i.e., containing the cyclohexane moiety, and derivatized with functional groups including carboxamide, ketal, ester, ether, and alcohol. Non-limiting examples include menthyl ethylamido oxalate (under the tradename FRESCOLAT® X-COOL® from Symrise), menthyl lactate (such as FRESCOLAT® ML Natural available from Symrise), and menthyl pyrrolidone carboxylate, also known as menthyl PCA (under the tradename QUESTICE® from Givaudan).

Hydrophobic compounds may be selected from capric and or caprylic triglycerides, grape seed oil, olive oil, micro-crystalline wax, shea butter, cocoa butter, lanolin, essential oil, peppermint oil, isohexadecane, petrolatum, silicone polymers including waxes and oils (selected from dimethicones, phenylated silicones and mixtures thereof), and mixtures thereof.

In some examples, the lubricating member may optionally comprise any other ingredients commonly found in commercially available lubricating members and skin care products more generally. The lubricating member may therefore contain other conventional lubricating member ingredients, including water-swellable release enhancing agents such as cross-linked polyacrylics (e.g., 2% to 7% by weight), colorants, skin feel/care actives such as water-soluble cationic polymers, surfactants, soaps (including interrupted soaps), antioxidants, preservatives, emollients, beard softeners, astringents, medicinal agents, plasticizers, additional lubricants, depilatories/keratolytic materials, tackifiers, skin-soothing agents, fragrances, compatibilisers, anti-inflammatory agents, antipruritic/counterirritant materials, and mixtures thereof. These ingredients may fall under the definition of hydrophobic compounds as used herein and should be included as such in determining the amount of the hydrophobic compound(s).

### Compositions

TABLE 1

| Comp. | |
|---|---|
| No. | Composition |
| 1 | A composition comprising, |
| | a lubricating material, wherein the lubricating material |
| | comprises a polyglutamic acid (PGA) material. |
| 2 | In one aspect of the composition 1 of Table 1, the composition |
| | further comprises a matrix material, wherein the matrix material |
| | comprises one of a polymer or a molecular structurant. |
| 3 | In one aspect of the composition 2 of Table 1, |
| | the polymer comprises at least one of ethylene |
| | vinyl acetate, polyethylene, polypropylene, |
| | polystyrene, butadiene-styrene copolymer, polyacetal, |
| | acrylonitrile-butadiene-styrene copolymer, polyurethane, or |
| | blends thereof, and the molecular structurant comprises at |
| | least one of a fatty acid, a fatty acid salt, or a fatty alcohol. |
| 4 | In one aspect of the compositions 1-3 of Table 1, the lubricating |
| | material is formed into a container. |
| 5 | In one aspect of the compositions 1-4 of Table 1, the PGA |
| | material has an average molecular weight over 100,000 Daltons. |
| 6 | In one aspect of the compositions 1-5 of Table 1, the PGA |
| | material forms discrete particles, and wherein 90% or more |
| | of the discrete particles pass through a 20 mesh screen. |
| 7 | In one aspect of the compositions 1-6 of Table 1, the PGA |
| | material comprises 5% to 90% of the lubricating member |
| | by weight. |
| 8 | In one aspect of the compositions 1-7 of Table 1, the PGA |
| | material comprises 30% to 70% of the lubricating member |
| | by weight. |
| 9 | In one aspect of the compositions 1-8 of Table 1, the |
| | composition further comprises a second lubricating material |
| | comprising at least one of a polyethylene oxide or a |
| | carbohydrate. |
| 10 | In one aspect of the compositions 1-9 of Table 1, the lubricating |
| | member is positioned on a hair removal device, the hair removal |
| | device comprising |
| | a. a housing having a lubricating surface; and |
| | b. at least one blade with a blade tip, wherein the blade tip is |
| | exposed on the lubricating surface of the housing, wherein the |
| | lubricating member is positioned on the lubricating surface of |
| | the housing. |
| 11 | In one aspect of the compositions 1-10 of Table 1, the PGA |
| | material has a formula of: |
| | 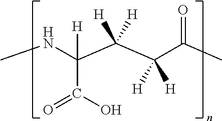 |
| | wherein n has a value of at least 700. |

TABLE 2

| Comp. | |
|---|---|
| No. | Composition |
| 1 | A composition comprising: |
| | a matrix material; and |
| | a lubricating material, wherein the lubricating material comprises |
| | a polyglutamic acid (PGA) material, |
| | wherein the PGA material comprises at least 5% of the |
| | lubricating composition by weight. |
| 2 | In one aspect of the composition 1 of Table 2, the matrix |
| | material comprises a molecular structurant. |
| 3 | In one aspect of the composition 2 of Table 2, the molecular |
| | structurant comprises at least one of a fatty acid, a fatty acid salt, |
| | or a fatty alcohol. |
| 4 | In one aspect of the compositions 1-3 of Table 2, the PGA |
| | material has an average molecular weight over 100,000 Daltons. |
| 5 | In one aspect of the compositions 1-4 of Table 2, the PGA |
| | material comprises 10% to 50% of the lubricating composition |
| | by weight. |
| 6 | In one aspect of the compositions 1-5 of Table 2, the |
| | composition further comprises a second lubricating material |
| | comprising one of polyethylene oxide or a carbohydrate. |
| 7 | In one aspect of the compositions 1-7 of Table 2, the PGA |
| | material has a formula of: |
| | 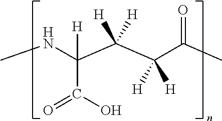 |
| | wherein n has a value of at least 700. |

An exemplary lubricating member in accordance with the present disclosure may comprise PGA material embedded in a HIPS matrix at a level of 5% to 90% by weight of the lubricating member and may be processed at a temperature of between 300° F. and 500° F. In one particular example, the lubricating member may comprise HIPS (34.875%); PGA material (54.875%); processing aids at 10% including polycaprolactone (CAPA 6506) and polyethylene glycol (Carbowax 4600 PEG); and an antioxidant at 0.25% (Irganox). The lubricating member is formed by extrusion at a temperature of greater than 365° F.

### Methods of Manufacture/Processing

The lubricating member may be formed using any method known in the art such as molding (including melt-forming), pressing, impregnation, spray-coating, fiber spinning, calendaring, printing, and extrusion. Some or all of the components of the lubricating member can be blended prior to molding or extrusion. For best results, it is preferred that the components are dry prior to blending. In summary, the method comprises the steps of providing a feed comprising the lubricating material and any additional materials that may be included such as the matrix material, and/or additional optional ingredients and forming the mixture by molding, pressing, impregnating, spray-coating, calendaring, printing, and/or extruding the mixture to form a solid lubricating member. Additional optional steps may be included depending on the process of manufacture that is utilized, e.g., heating the feed to an appropriate processing temperature, mixing and shearing. The lubricating member may be formed separately from the hair removal device or formed directly onto a portion of the hair removal device, including the hair removal head.

The PGA material may be provided as a particulate powder. The powder may have an average particle size of 250 microns. Preferably, the particulates have an average particle size distribution of from 10 to 1200 microns and preferably from 50 to 1000 microns, more preferably 840 microns. Alternatively, the particulate size may be such that 90% of particles pass through a 20 mesh screen, i.e., 90% of particles are less than about 840 microns in diameter. Mesh size is defined as the number of openings in one square inch of a screen, i.e., a 20 mesh screen will have 20 openings in one square inch. In one example, the lubricating member may comprise PGA material in the form of discrete particles, in which at least 90% of the discrete particles have a size less than 840 microns. Particle size was measured according to ASTM E2651-19 section 14 (laser diffraction) using a Beckman Coulter LS 13 320 XR Particle size analyzer with a dry powder module.

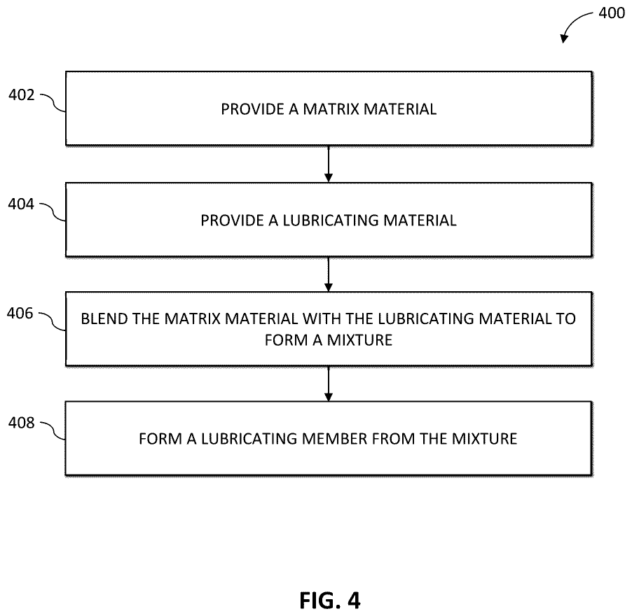

FIG. 4 illustrates an exemplary method 400 for forming a lubricating member for use in a hair removal device, in accordance with the present disclosure. At 402, a matrix material is provided. As discussed above, the matrix material may be a polymer, such as EVA or HIPS, and/or a molecular structurant, such as behenyl alcohol. At step 404, a lubricating material is provided. As discussed above, the lubricating material may preferably be PGA material. At 406, the matrix material is blended with the lubricating material to form a mixture. At 408, a lubricating member is formed from the mixture, after which the method 400 may conclude. In one example, forming the lubricating member may comprise a process selected from a group consisting of extrusion, melt-formation, molding, pressing, and printing.

### Extrusion

The lubricating member may be extruded. Extrusion is particularly preferred where the lubricating member comprises a matrix material which is a matrix polymer such as HIPS or EVA. The lubricating components can be pre-mixed prior to mixing with the matrix polymer. The extrusion process generally consists of blending the components, which generally requires that the matrix material be melted with heat.

The blended components may be extruded (e.g., which applies shear), such as through a HAAKE™ System 90 (Thermo Scientific) ¾ inch (˜1.91 cm) diameter extruder with a barrel pressure of 1000 psi to 2000 psi (˜6.90 MPa-13.8 MPa), a rotor speed of 10 rpm to 50 rpm, and a temperature of 150°-185° C. and a die temperature of 170°-185° C. Alternatively, a 1¼ inch (˜3.18 cm) single screw extruder may be employed with a processing temperature of 175°-200° C., preferably 185°-190° C., a screw speed of 20 rpm to 50 rpm, preferably 25 rpm to 35 rpm, and an extrusion pressure of 1800 psi to 5000 psi (˜12.4-34.5 MPa), preferably 2000 psi to 3500 psi (˜13.8 MPa-24.1 MPa). The extruded lubricating member may be cooled to 25° C. by any conventional means (i.e., air cooling).

The matrix polymer is generally heated above its glass transition temperature. The matrix polymer may be chosen to allow for lower processing temperatures. For example, the matrix polymer may be EVA and may have a glass-transition temperature less than 130° C.

The blended components may be extruded through a Rondol 18, 18 mm diameter extruder with a barrel pressure of 500-1000 psi, a rotor speed of 10 to 50 rpm, and a temperature of 100°-160° C. and a die temperature of 100°-160° C. Alternatively, a 1½ inch single screw extruder may be employed with a processing temperature of 100°-160° C., preferably 110-130° C., a screw speed of 20 to 50 rpm, preferably 25 to 50 rpm, and an extrusion pressure of 1800 to 7500 psi, preferably 4000 to 6500 psi. Other extrusion conditions can also be employed. The extruded strip is cooled to 25° C. In one example, one or more feeds can be preheated or they can be fed in at ambient temperature. Methods for forming extruded lubricating members comprising EVA are further described in U.S. Pat. No. 5,349,750 and U.S. Patent Application Publication Nos. 2017/0334082 and 2018/0117780.

### Injection Molding

The lubricating member may be injection molded. To injection mold the lubricating member, the blended components may first be extruded into pellets. This can be done on a 1¼ or 1½ inch (˜3.18 cm or 3.81 cm) single screw extruder at a temperature of 120° C.-180° C., preferably 140° C.-150° C., with a screw speed of 20 rpm to 100 rpm, preferably 45 rpm to 70 rpm. The pellets are then molded (with or without re-melting) in either a single material molding or multi-material molding machine, which may be single cavity or multi-cavity, and optionally equipped with a hot-runner system. The process temperature can be from 165° C. to 250° C., preferably from 180° C. to 225° C. The injection pressure should be sufficient to fill the part completely without excess flashing. Depending on the cavity size, configuration and quantity, the injection pressure can range from 300 to 2500 psi (˜2.07-17.2 MPa). The cycle time is dependent on the same parameters and can range from 3 to 30 seconds, with the optimum generally being 6 to 15 seconds.

### Melt Formed

The lubricating member may be manufactured using a melt forming process. Melt forming is particularly preferred where the lubricating member comprises a matrix material which comprises a molecular structurant such as behenyl alcohol. In such processes, the ingredients are heated and stirred until melted. The molten material is then transferred into a mold, and the temperature is reduced. Optionally, pressure may be applied. The lubricating member is removed from the mold upon cooling.

The ingredients may be premixed in one fashion or another. The process may include combining a lipid phase (e.g., comprising the lipophilic structurant) and a liquid phase as previously discussed. The lipid phase and/or the liquid phase may include the lubricating material, or the lubricating material may be added as a separate phase.

The lipid phase may comprise a lipophilic structurant. The lipid phase may comprise from 10% to 70%, preferably from 10% to 60%, more preferably from 20% to 40%, even more preferably from 25% to 35% by weight of the lubricating member of a lipophilic structurant.

### Pressing

The lubricating member may be provided in the form of a tablet, bar or other solid form comprising compressed powder. For such examples, the lubricating member may be manufactured whereby the lubricating material and other solid dry components (if included) are provided as particulates and mixed. The particulate material(s) is solid at 25° C. and preferably has a melting point of 30° C. or more. The lubricating member thus may comprise from 10% to 90% by weight of a particulate material(s) of the lubricating material.

The lubricating member may comprise from 40% to 90% lubricating material. The lubricating member may be formed by compression such as cold compression as disclosed in U.S. Patent Application Publication No. 2011/0041865.

The lubricating member may comprise greater than 90% of the lubricating material up to and including 100% of the lubricating material (absent the preserving agent(s) of the present invention). The lubricating member may be formed by compression such as ultrasonic-compression as disclosed U.S. Patent Application Publication No. 2012/0023763.

The terms “compression,” “compression molding,” and “compression compaction” as used herein refer to a process by which the bulk density of a particulate or powder is reduced to form a solid by the application of pressure. Typically, this is performed without the application of external shear force or heat. Preferably the compression compaction is conducted below the melting point of at least one, preferably all, the particulate components, preferably at ambient temperature of 25° C. As such, the particulates retain their integrity after the compression process and are typically visible by the naked eye after the compression process is completed.

In certain examples, additional energy sources such as heat or ultrasonic energy may be applied during or after compression to increase inter-particulate bonding and increase the rigidity of the resulting lubricating member. Application of additional energy preferably does not result in any substantial melting of the particulate material. Preferably, this method does not require an extrusion or injection molding step or the application of energy sources such as heat.

The lubricating member may thus be provided in the form of a compressed solid formed from particulates. The lubricating member is compressed preferably directly into a preform or container, such as a tray. This may be achieved using any method and equipment known in the art in the art such as a die press. The bulk density of the particulate material prior to compression is typically 300 to 600 kg/m³ and increases to 1000 to 1200 kg/m³ following compression. Bulk density thus may be increased by 200% to 400% after the compression. Without wishing to be bound by theory, it has been found that the use of particulate compression manufacturing, preferably cold particulate compression (i.e., at 25° C. or less), to form the lubricating member enables highly lubricous components to be incorporated therein without negatively impacting the water solubility and lubrication performance of the water-soluble polymer. This also allows flexibility in the size of the resulting lubricating member to be used for multiple razor cartridges.

### Printing

The lubricating material may be printed onto the razor cartridge, which may include components such as but not limited to, the lubricating member or composition, razor blade, and cartridge housing.

The lubricating member or composition may be modified with a lubrication control printed pattern as disclosed in U.S. Patent Application Publication No. 2016/0199990.

### TEST METHODS

### Rheology Testing

Testing was performed to compare the viscous (loss) modulus and the elastic (storage) modulus of various lubricating members. Samples were a solution of 0.5% of the lubricating materials listed below in Table 1, 0.5% of a phenoxyethanol preservative, and water.

TABLE 1
Lubricating Materials

| Sample Number | Lubricating Material |
|---|---|
| Sample 1 | PGA SHMW* |
| Sample 2 | PEO 308** |
| Sample 3 | PEO Coag** |
| Sample 4 | PEO N60K** |
| Sample 5 | PEO N750** |

Suppliers: *Bloomage Biotechnology
**Dow ™ Chemicals

Samples were tested using a frequency sweep on a TA Instruments™ Ares G2 rheometer with the settings listed below in Table 2.

TABLE 2
Testing Settings

| Plate Diameter | 50 | mm |
|---|---|---|
| Radian Cone Angle | 1° | |
| Gap Size | 0.023 | mm |
| Temperature Setpoint | 25° | C. |
| Frequency | 0.1-100 | Hz |
| Strain | 3% | |
| Frequency Sweep | 7 | pts/decade |

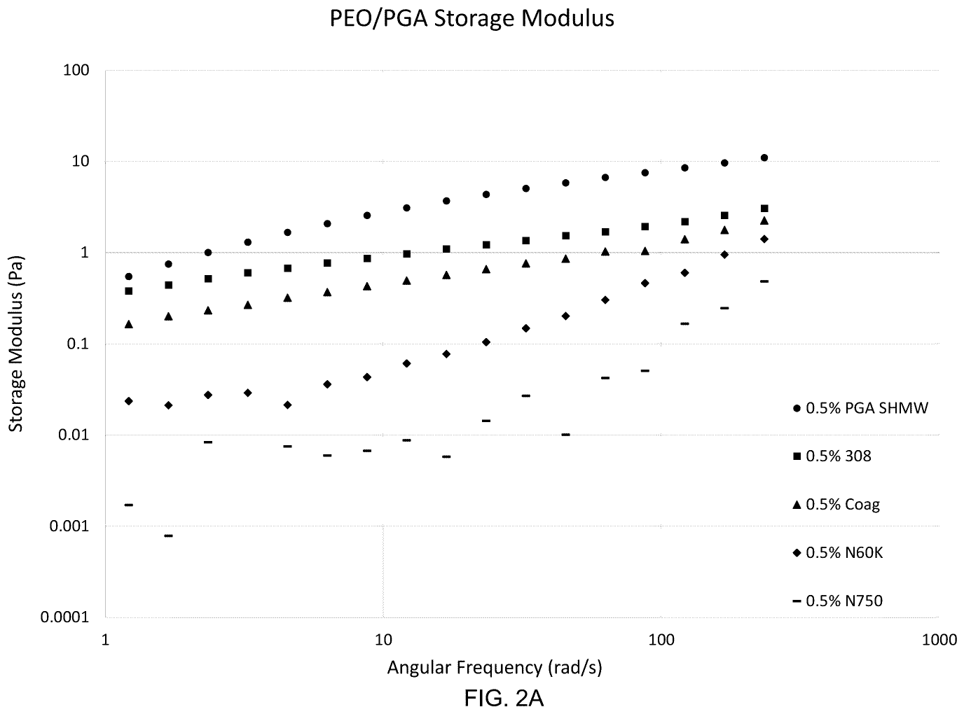

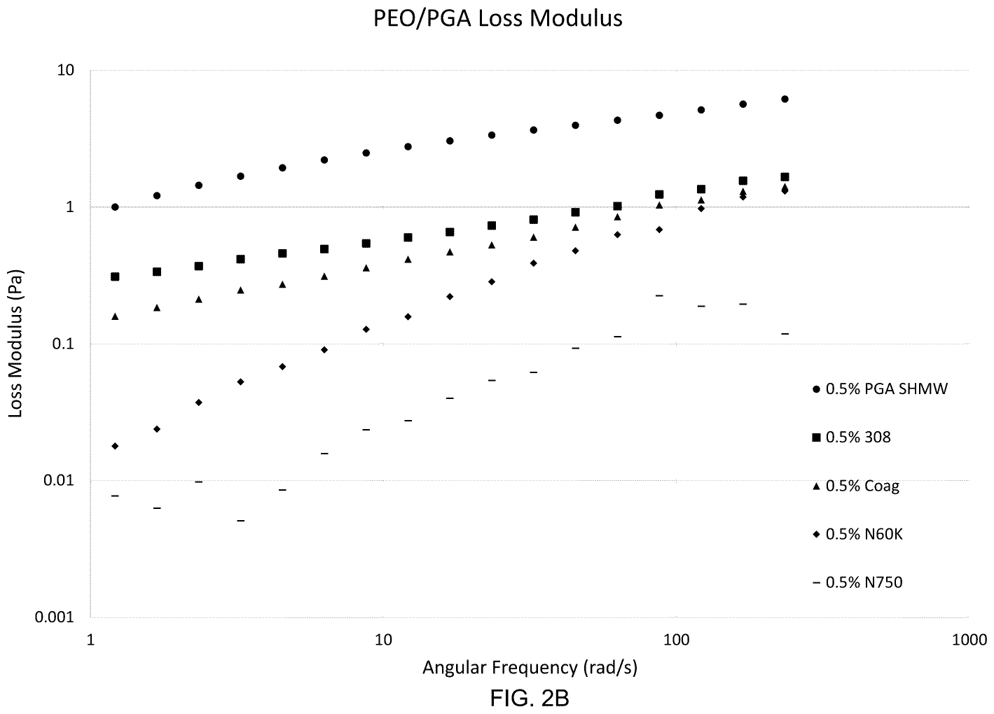

As shown in FIGS. 2A and 2B, the sample containing PGA material (Sample 1) had a higher viscous module and elastic modulus than the samples containing PEO (Samples 2-5). These higher moduli are believed to translate into improved performance of the PGA material in a lubricating member, as discussed below. Additionally, without intending to be bound by theory, it is believed that a lubricating member with PGA material is less stringy than a PEO-containing lubricating member. As stringiness is perceived as a negative quality by consumers, the believed lower stringiness of PGA material may lead to consumers perceiving a higher quality in lubricating members comprising PGA material, as compared to lubricating members comprising PEO.

### Viscosity Synergy Testing

The viscosity synergy between PGA and PEO as depicted in FIG. 5 is discussed above. Samples were evaluated as mixtures of PGA with PEO or as (control) mixtures of differing PEO materials. Table 3 lists the lubricating materials tested. Samples were a solution of either 0.5% (w/w) or 1.0% (w/w) of the lubricating materials listed below in Table 3, 0.5% of a phenoxyethanol preservative, and water

TABLE 3
Lubricating Materials

| | | | Total | | | | | |
|---|---|---|---|---|---|---|---|---|
| | | | Lubricating | | | | | |
| | First | Second | Material | | | | | |
| | Lubricating | Lubricating | (w/w % in | Ratios of First:Second | | | | |
| | Material | Material | water) | Lubricating Material | | | | |
| Example 6 | PGA | PEO | 0.5% | 10:90 | 25:75 | 50:50 | 75:25 | 90:10 |
| (Inventive) | SHMW* | Coag** | | | | | | |
| Example 7 | PGA | PEO | 1.0% | 10:90 | 25:75 | 50:50 | 75:25 | 90:10 |
| (Inventive) | SHMW* | Coag** | | | | | | |
| Example 8 | PEO | PEO | 1.0% | 0:100 | 25:75 | 50:50 | 75:25 | 100:0 |
| (Comparative) | N60K** | Coag** | | | | | | |

Suppliers: *Bloomage Biotechnology
**Dow ™ Chemicals

Samples were tested using a TA Instruments™ Ares G2 rheometer with the settings listed below.

TABLE X
Testing Settings

| Plate Diameter | 50 | mm |
|---|---|---|
| Radian Cone Angle | 1° | |
| Gap Size | 0.023 | mm |
| Temperature Setpoint | 25° | C. |
| Shear Rates | 1e−3 to 1000 1/s | |
| Points per Decade | 15 | |
| % Tolerance | 5% | |
| Max equilibrium time | 180 | s |

| | |
|---|---|
| Consecutive within | 5 |

The synergy of the combined lubricating materials is shown as the gain in viscosity for the combination of materials versus either material alone. This can be calculated using the Gambill Method which compares the experimentally observed viscosity to the expected viscosity for the mixture.
The gain is defined as:

$$Gain = \frac{Experimental Mixture Viscosity}{{v}_{m}}$$

Where vₘ is calculated as:

$${v}_{m}^{\frac{1}{3}} = {x}_{a} {v}_{a}^{\frac{1}{3}} + {x}_{b} {v}_{b}^{\frac{1}{3}}$$

with:
xₐ=weight fraction of the first lubricating material
x_{b}=weight fraction of the first lubricating material
vₐ=viscosity of the first lubricating material (tested under the same conditions)
v_{b}=viscosity of the second lubricating material (tested under the same conditions)

### Use Testing

The following example formulations of lubricating members were made according to Table 3 below. All values are w/w %.

TABLE 3
Lubricating Member Compositions

| Control | % | Experimental | % |
|---|---|---|---|
| Elvax 750* | 31 | Elvax 750* | 31 |
| PEO 308* | 41.40 | PGA HMW** | 69 |
| PEO N750* | 27.60 | | |

Suppliers: *Dow ™ Chemicals
**Shandong Freda Biotechnology

The sample lubricating members were produced by adding 0.5 g of each powder blend into a Carver™ hot press die at 300° F. and 4000 PSI for 30 seconds. The test included lubricating members containing a PEO-based lubricating member (Control) or a lubricating member in accordance with the present disclosure (Experimental), as set out in Table 3 above. Panelists hydrated the lubricating member, applied it to their skin, and then rated the performance of the lubricating member on a scale from 1 to 5 with 1 being the worst performance and 5 being the best performance. Specifically, the lubricating members were rated for glide over the skin (Glide), providing the right amount of lubrication (Lubrication), ease of rinse (Rinse), and leaving skin feeling smooth and/or soft (Skin Feel). The average performance scores are listed in Table 4 below.

TABLE 4
Average Performance Score

| | Control | Experimental |
|---|---|---|
| Glide | 4.0 | 4.3 |
| Lubrication | 4.1 | 4.3 |
| Rinse | 4.7 | 4.6 |
| Skin Feel | 4.6 | 4.1 |

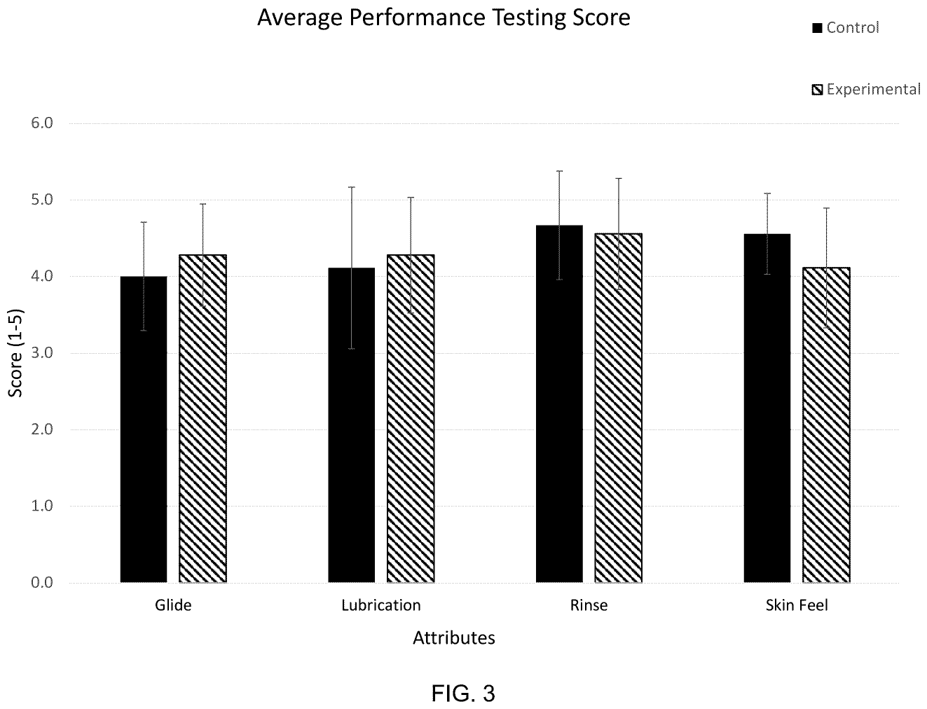

As shown in Table 4 and FIG. 3, the lubricating members containing PGA material (Experimental) performed similarly to the lubricating members containing PEO (Control).

### Example Formulation

The examples below demonstrate producing samples of lubrastrip of ethylene vinyl acetate (EVA) with PGA:

| Materials | Example 1 | Example 2 | Example 3 |
|---|---|---|---|
| EVA* | 31.0% | 31.0% | 52.8% |
| PEO Coag* | 36.8% | 0% | 0% |
| PGA** | 20.0% | 56.8% | 35.0% |
| Process aids*** | 12.2% | 12.2% | 12.2% |

Suppliers: *Dow ™ Chemicals
**Bloomage Biotechnology
***PEG4600 (Dow ™ Chemicals), PCL CAPA 6506 (Ingevity), Ralox 35 (Wego), Citric acid (Jungbunzlauer)

The illustrations presented herein are not intended to be actual views of any particular substrate, apparatus (e.g., device, system, etc.), or method, but are merely idealized and/or schematic representations that are employed to describe and illustrate various examples of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular examples of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A lubricating member for a hair removal device, wherein the lubricating member comprises:
a lubricating material, wherein the lubricating material comprises a polyglutamic acid (PGA) material.

2. The lubricating member of claim 1, further comprising a matrix material, wherein the matrix material comprises one of a polymer or a molecular structurant.

3. The lubricating member of claim 2, wherein the polymer comprises at least one of ethylene vinyl acetate, polyethylene, polypropylene, polystyrene, butadiene-styrene copolymer, polyacetal, acrylonitrile-butadiene-styrene copolymer, polyurethane, or blends thereof, and wherein the molecular structurant comprises at least one of a fatty acid, a fatty acid salt, or a fatty alcohol.

4. The lubricating member of claim 1, wherein the lubricating material is formed into a container.

5. The lubricating member of claim 1, wherein the PGA material has an average molecular weight over 100,000 Daltons.

6. The lubricating member of claim 1, wherein the PGA material forms discrete particles, and wherein 90% or more of the discrete particles pass through a 20 mesh screen.

7. The lubricating member of claim 1, wherein the PGA material comprises 5% to 90% of the lubricating member by weight.

8. The lubricating member of claim 1, wherein the PGA material comprises 30% to 70% of the lubricating member by weight.

9. The lubricating member of claim 1, further comprising a second lubricating material comprising at least one of a polyethylene oxide or a carbohydrate.

10. The lubricating member of claim 1, wherein the lubricating member is positioned on a hair removal device, the hair removal device comprising
a. a housing having a lubricating surface; and
b. at least one blade with a blade tip, wherein the blade tip is exposed on the lubricating surface of the housing, wherein the lubricating member is positioned on the lubricating surface of the housing.

11. The lubricating member of claim 1, wherein the PGA material has a formula of: 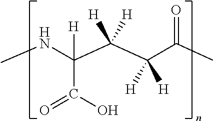
wherein n has a value of at least 700.

12. A lubricating composition comprising:
a matrix material; and
a lubricating material, wherein the lubricating material comprises a polyglutamic acid (PGA) material,
wherein the PGA material comprises at least 5% of the lubricating composition by weight.

13. The lubricating composition of claim 12 wherein the matrix material comprises a molecular structurant.

14. The lubricating composition of claim 1, wherein the molecular structurant comprises at least one of a fatty acid, a fatty acid salt, or a fatty alcohol.

15. The lubricating composition of claim 12 wherein the PGA material has an average molecular weight over 100,000 Daltons.

16. The lubricating composition of claim 12, wherein the PGA material comprises 5% to 50% of the lubricating composition by weight.

17. The lubricating composition of claim 12, further comprising a second lubricating material comprising one of polyethylene oxide or a carbohydrate.

18. The lubricating member of claim 12, wherein the PGA material has a formula of: 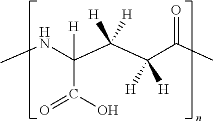
wherein n has a value of at least 700.

19. A method of forming a lubricating member for use on a hair removal device, the method comprising:
providing a matrix material;
providing a lubricating material, wherein the lubricating material is a polyglutamic acid material;
blending the matrix material with the lubricating material to form a mixture; and
forming a lubricating member from the mixture.

20. The method of claim 19, wherein forming the lubricating member comprises a process selected from a group consisting of extrusion, melt-formation, molding, pressing, and printing.
